(19) United States
(12) Patent Application Publication
(10) Pub. No.: US 2009/0295725 A1
(43) Pub. Date: Dec. 3, 2009

(54) SCROLL WHEEL MODULE

(75) Inventor: Chin-Wen CHOU, Taipei Hsien (TW)

Correspondence Address: Muncy, Geissler, Olds & Lowe, PLLC, P.O. BOX 1364, FAIRFAX, VA, 22038-1364, US

(73) Assignee: ZIPPY TECHNOLOGY CORP.

(21) Appl. No.: 12/131,561

(22) Filed: Jun. 2, 2008

(51) Int. Cl. G06F 3/033

(52) U.S. Cl. 345/163

(57) ABSTRACT

The present invention discloses a scroll wheel module, which comprises: a scroll wheel; a displacement seat accommodating the scroll wheel; and a carry seat arranged outside the displacement seat. The displacement seat has a receiving member, which receives the scroll wheel and implements the displacement seat to move in the same direction as the scroll wheel moves. The displacement seat has at least one actuation member, and the carry seat has at least one instruction switch corresponding to the actuation member. At least one support member is arranged in between the displacement seat and the carry seat. The support member implements the displacement seat to move horizontally inside the carry seat, which makes the actuation member trigger the instruction switch to generate and output an instruction signal. Thereby, the assembling process of the scroll wheel module is simplified, and the volume of the scroll wheel module is reduced.

### FIELD OF THE INVENTION

The present invention relates a scroll wheel input device, particularly to a modularized scroll wheel input device.

### BACKGROUND OF THE INVENTION

Most of the current computer systems adopt a GUI (Graphical User Interface) operating system to make users easily understand the information on the screen and conveniently operate the computer. Therefore, in addition to the traditional input device—the keyboard, the user may also use an easy-to-use pointer device, such as a mouse or a trackball, to operate the computer, wherein the user can move the pointer device to control the cursor on the screen and press one functional button of the pointer device to input an instruction. Thus, it is no more necessary for users to enter a complicated instruction or programming language with a keyboard. In addition to the above-mentioned functional buttons, the pointer device usually has a scroll wheel for viewing webpages and documents rapidly. For example, U.S. Pat. No. 5,912,661 and U.S. Pat. No. 6,188,389 disclosed related technologies, wherein the user can move the contents of a screen along a direction via only rotating the scroll wheel, whereby the movement range of the pointer device is reduced, the browse speed is increased, and the operation efficiency is promoted.

With the increasing contents and complexity of information, the unidirectional browsing function cannot meet requirement any more, and multidirectional pointer devices were developed, such as those disclosed in U.S. Pat. No. 6,987,505, U.S. Pat. No. 7,079,110, U.S. Pat. No. 7,205,977, and U.S. Pat. No. 7,324,090. In the above-mentioned prior-art multidirectional pointer devices, a scroll wheel is rotatably installed in a support seat; a rotation detector arranged on one end of the support seat or microswitches triggered by extension arms arranged around the support seat are used to detect the rotation of the scroll wheel and generate a signal corresponding to the rotation displacement. Further, support frames are fixedly installed at the front and rear sides of the support seat to reflect the swing displacement of the scroll wheel having a left-right scrolling capability. The above-mentioned support seat, microswitches, rotation detector, support frames, etc., have to be installed on a circuit substrate separately. In assembling, the components are secured to the circuit substrate separately via complicated soldering processes. With the increasing functions of pointer devices, the assembling process should be more and more complicated. Besides, the components dispersively arranged on the circuit substrate should occupy much space and reduce the space-efficiency.

### SUMMARY OF THE INVENTION

The primary objective of the present invention is to provide a modularized multidirectional scroll wheel. To achieve the above-mentioned objective, the present invention proposes a scroll wheel module, which comprises: a scroll wheel; a displacement seat accommodating the scroll wheel; and a carry seat arranged outside the displacement seat. The displacement seat has a receiving member, which receives the scroll wheel and implements the displacement seat to move in the same direction as the scroll wheel moves. The displacement seat has at least one actuation member, and the carry seat has at least one instruction switch corresponding to the actuation member. At least one support member is arranged in between the displacement seat and the carry seat; the support member implements the displacement seat to move horizontally inside the carry seat, which makes the actuation member trigger the instruction switch to generate and output an instruction signal.

The support member extends from the displacement seat and presses against the carry seat. An elastic member is arranged below the displacement seat and implements the displacement seat to have a tilt displacement travel. The carry seat has a motion hole where the receiving member is pivotally installed. A movement member is arranged within the range of the tilt displacement travel of the displacement seat. A first incline and a second incline are oppositely arranged in the displacement seat and the movement member. When the displacement seat has a tilt displacement, the first and second inclines implement the movement member to slide and trigger a tilt detection switch. Besides, the carry seat has a rotation detection unit used to detect the rotation displacement of the scroll wheel.

In the present invention, the carry seat can be fabricated into a one-piece component. Alternatively, the carry seat can be formed via assembling a first workpiece and a second workpiece, and the first and second workpieces are fastened to each other with a fastening member.

Via the above-mentioned structure of the scroll wheel module of the present invention, the scroll wheel can have horizontal displacement and tilt displacement inside the carry seat and thus has a multidirectional instruction function. Besides, the design of the displacement seat and the carry seat can realize the modularization of a scroll wheel device.

### BRIEF DESCRIPTION OF THE DRAWINGS

FIG. 1 is a perspective view of a scroll wheel module according to a preferred embodiment of the present invention.

FIG. 2A and FIG. 2B are exploded views of a scroll wheel module according to a preferred embodiment of the present invention.

FIG. 3A, FIG. 3B and FIG. 3C are diagrams schematically showing the process of a horizontal displacement in a scroll wheel module according to a preferred embodiment of the present invention.

FIG. 4A and FIG. 4B are two sectional diagrams schematically showing the process of a tilt displacement in a scroll wheel module according to a preferred embodiment of the present invention.

FIG. 5A and FIG. 5B are another two sectional diagrams schematically showing the process of a tilt displacement in a scroll wheel module according to a preferred embodiment of the present invention.

### DETAILED DESCRIPTION OF THE PREFERRED EMBODIMENTS

Below, the technical contents of the present invention are to be described in detail in cooperation with the drawings.

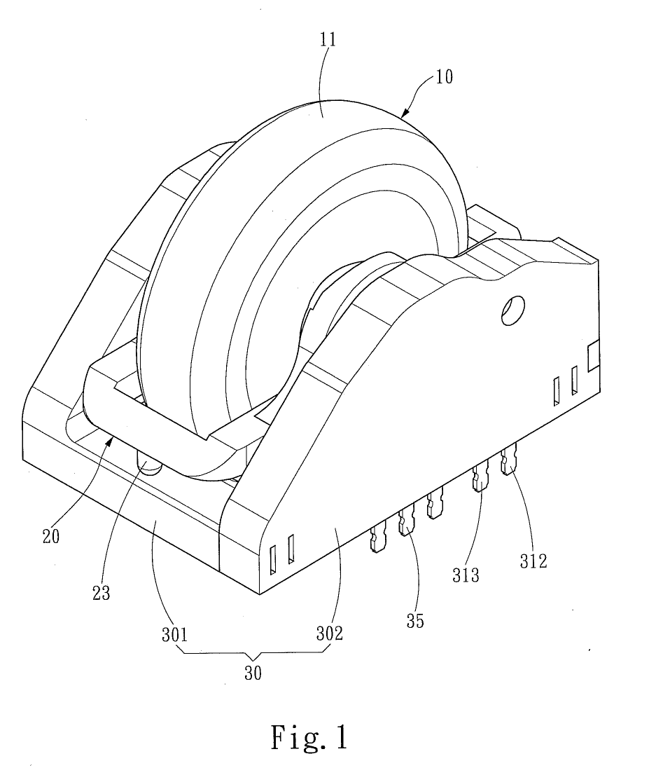

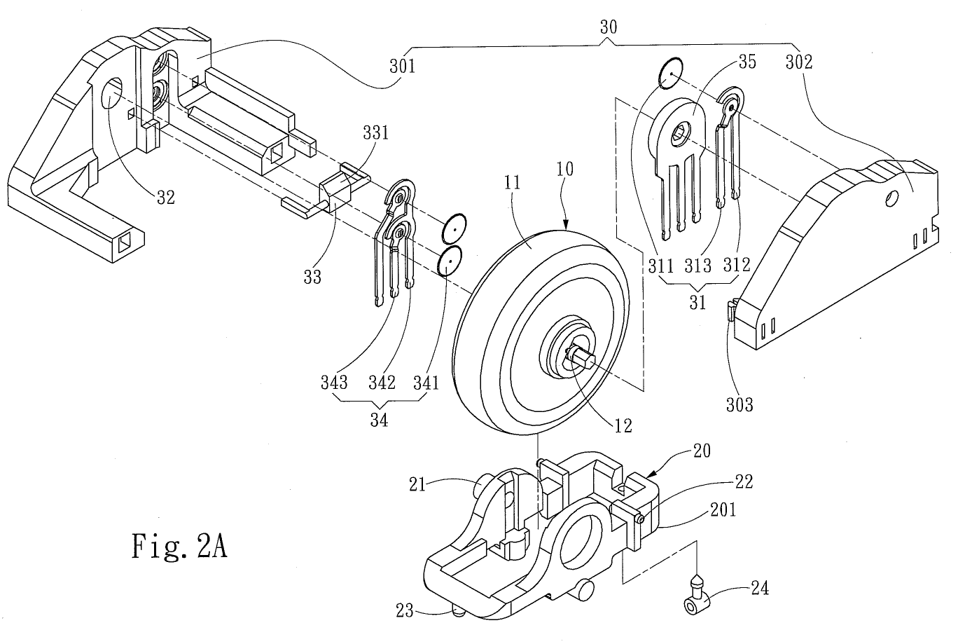

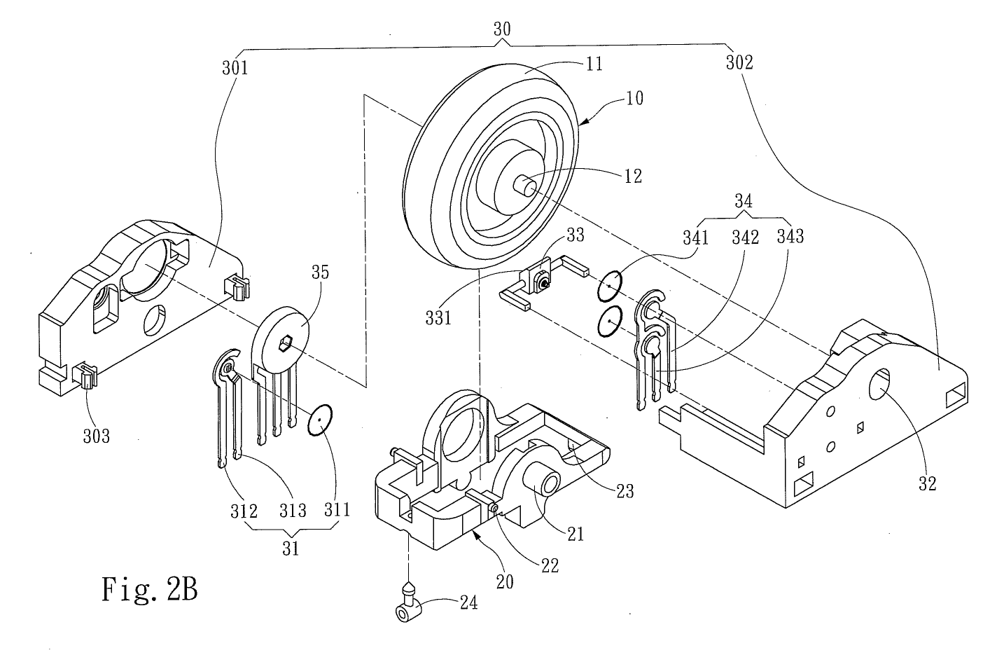

Refer to FIG. 1 and FIGS. 2A-2B respectively a perspective view and exploded views according to a preferred embodiment of the present invention. The scroll wheel module of the present invention comprises: a scroll wheel 10; a displacement seat 20 accommodating the scroll wheel 10; and a carry seat 30 arranged outside the displacement seat 20. The scroll wheel 10 has a wheeling portion 11 that a user wheels to rotate the scroll wheel 10, and an axle portion 12 functioning as the rotation axis of the scroll wheel 10. The displacement seat 20 has a receiving member 21, which receives the axle portion 12 of the scroll wheel 10 and implements the displacement seat 20 to move in the same direction as the scroll wheel 10 moves. The displacement seat 20 has at least one actuation member 22, and the carry seat 30 has at least one instruction switch 31 corresponding to the actuation member 22. At least one support member 23 is arranged in between the displacement seat 20 and the carry seat 30; the support member 23 implements the displacement seat 20 to move horizontally inside the carry seat 30, which makes the actuation member 22 trigger the instruction switch 31 to generate and output an instruction signal.

In this embodiment, the support member 23 extends from the displacement seat 20 and presses against the carry seat 30. The displacement seat 20 can undertake a tilt displacement with respect to the carry seat 30. An elastic member 24 is arranged in between the displacement seat 20 and the carry seat 30 and implements the displacement seat 20 to have a tilt displacement travel. If a printed circuit board (not shown in the drawing) is used in the present invention, the elastic member 24 may be installed on the printed circuit board. The elastic member 24 may be a spring, an elastic rubber, or a mechanical elastic element. The carry seat 30 has a motion hole 32 where the receiving member 21 is pivotally installed, and the motion hole 32 is slightly greater than the external diameter of the receiving member 21, so that the receiving member 21 can move inside the motion hole 32. A movement member 33 is arranged within the range of the tilt displacement travel of the displacement seat 20 and used to trigger a tilt detection switch 34. A first incline 201 and a second incline 331 are oppositely arranged in the displacement seat 20 and the movement member 33.

The above-mentioned instruction switch 31 and tilt detection switch 34 may be realized by a variety of devices, such as a microswitch. In this embodiment, the instruction switch 31 and tilt detection switch 34 respectively have pressing elastic platelets 311 and 341, common electrodes 312 and 342 separately contacting the pressing elastic platelets 311 and 341 normally, trigger electrodes 313 and 343 separately contacting the common electrodes 312 and 342 when the pressing elastic platelets 311 and 341 are pressed. The present invention has the instruction switch 31 and tilt detection switch 34 to detect the displacement travel of the scroll wheel 10 and further has a rotation detection unit 35 arranged in the carry seat 30 and used to detect the rotation displacement of the scroll wheel 10. The rotation detection unit 35 may be an optical grating type, a rotational electrode type, or an electronic type detection module. In the present invention, the carry seat 30 may be fabricated into a one-piece component or formed via assembling a first workpiece 301 and a second workpiece 302. The first and second workpieces 301 and 302 are fastened to each other with a fastening member 303.

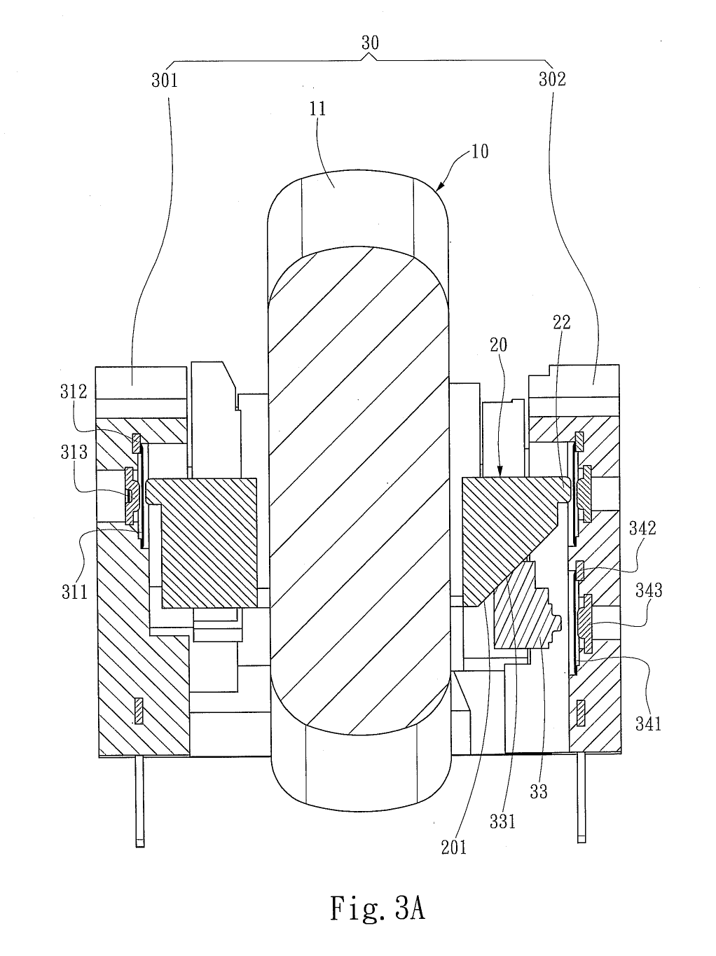

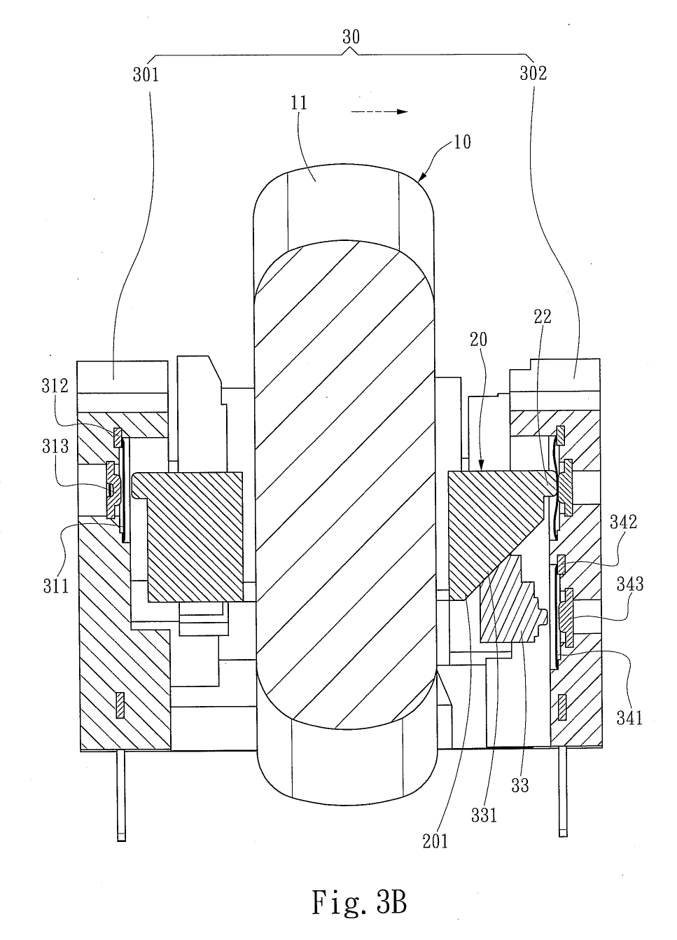

Refer to FIG. 3A, FIG. 3B and FIG. 3C diagrams schematically showing the process of a horizontal displacement according to a preferred embodiment of the present invention. As shown in FIG. 3A, the displacement seat 20 is installed inside the carry seat 30, and the support member 23 of the displacement seat 20 presses against the carry seat 30. As shown in FIG. 3B and FIG. 3C, the movement of the scroll wheel 10 will activate the displacement seat 20 to move in the same direction; when the user pushes the scroll wheel 10 horizontally, the displacement seat 20 will also move horizontally inside the carry seat 30. Within the range of the horizontal displacement, the actuation member 22 of the displacement seat 20 will press the pressing elastic platelets 311 of the instruction switch 31, which will enable the electric conduction of the common electrode 312 and the trigger electrode 313 and make the instruction switch 31 generate and output an instruction signal.

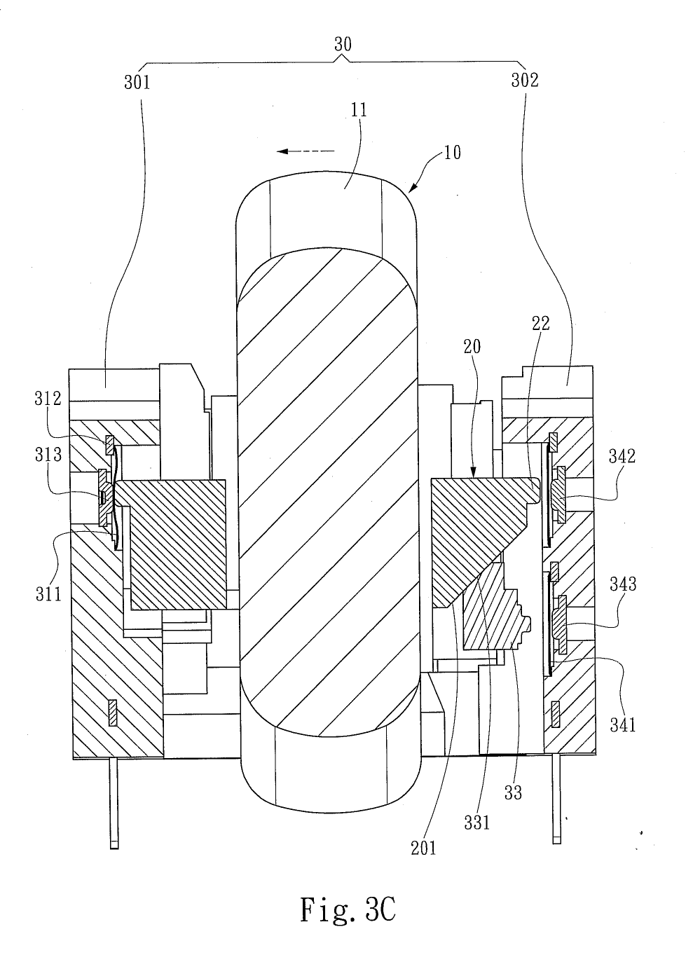

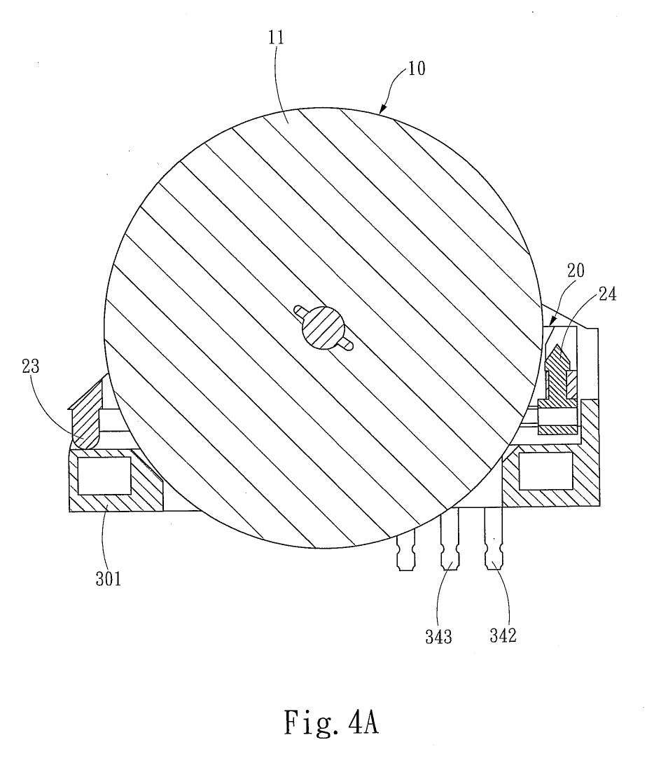

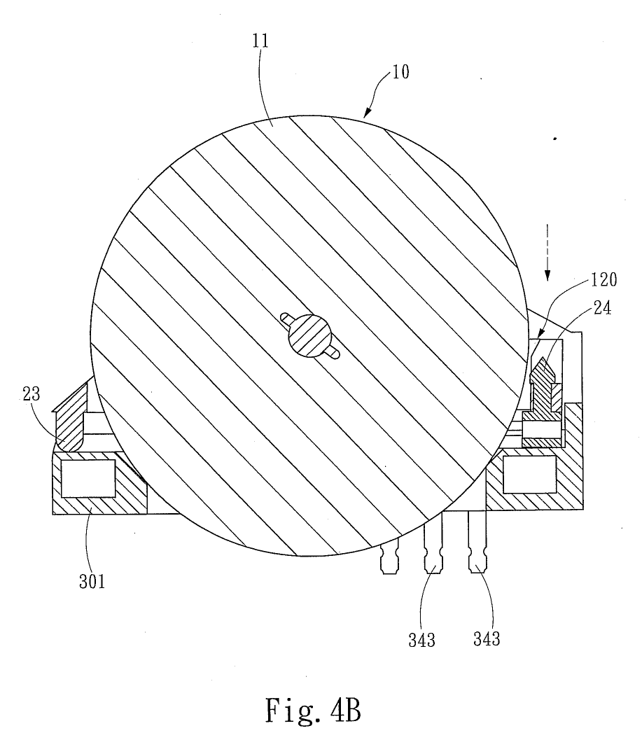

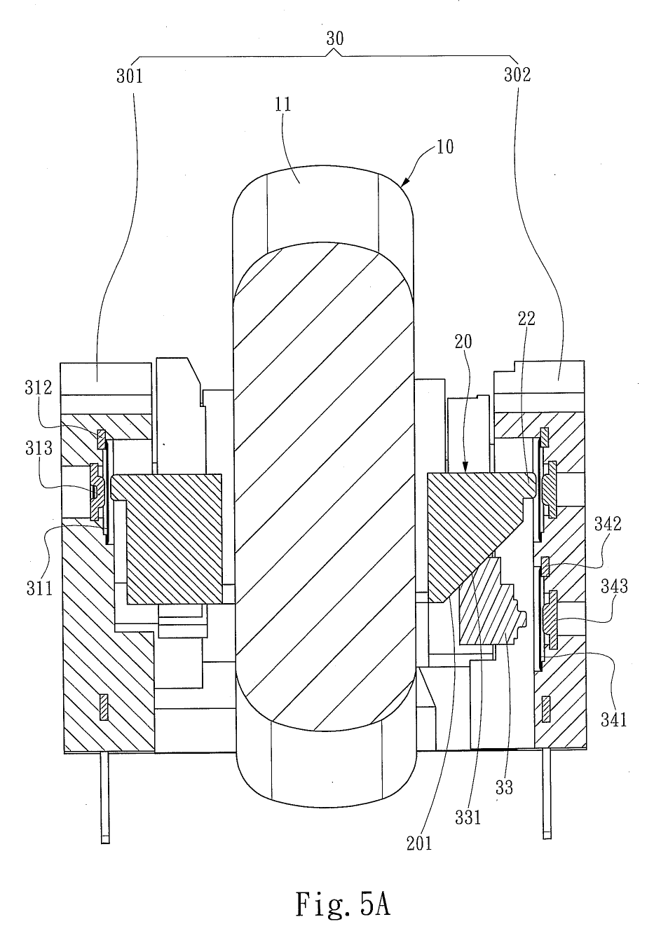

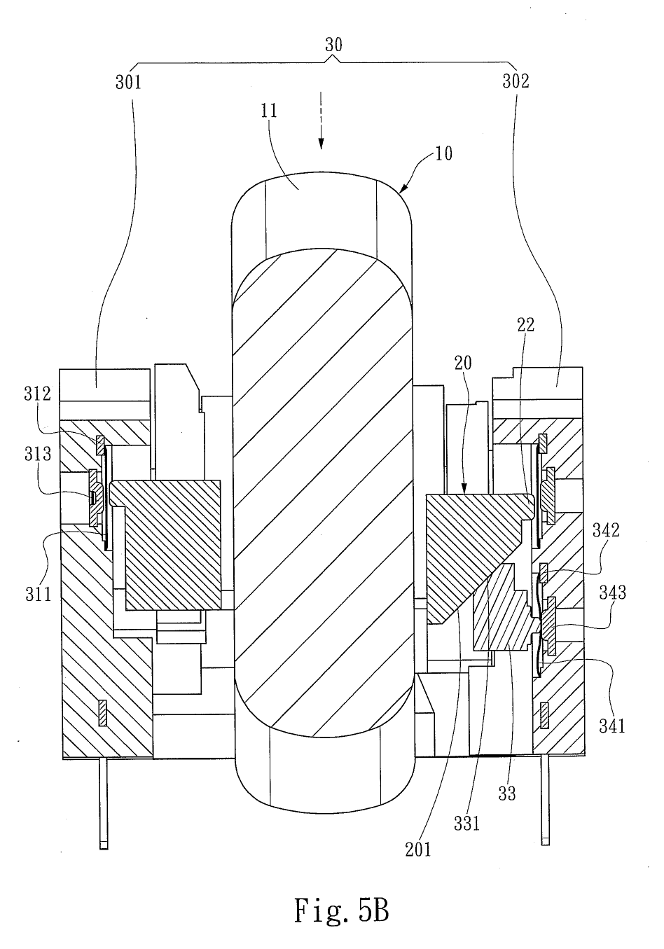

Refer to FIG. 4A, FIG. 4B, FIG. 5A and FIG. 5B diagrams schematically showing the process of a tilt displacement according to a preferred embodiment of the present invention. As shown in FIG. 4A, the displacement seat 20 is supported in the carry seat 30 by the support member 23 and the elastic member 24. As shown in FIG. 4B, when the user presses the scroll wheel 10 downward from the wheeling portion 11, the displacement seat 20 will tilt toward the elastic member 24 with the support member 23 being a fulcrum. As shown in FIG. 5A and FIG. 5B, the movement member 33, which is arranged between the displacement seat 20 and the carry member 30, is thus pushed by the displacement seat 20 toward the tilt detection switch 34 along the first incline 201 and the second incline 331. Then, the movement member 33 presses the pressing elastic platelet 341, which will enable the electric conduction of the common electrode 342 and the trigger electrode 343 and make the tilt detection switch 34 output an corresponding instruction signal.

In the scroll wheel module of the present invention, the scroll wheel can undertake a horizontal displacement travel and a tilt displacement travel, which enables the multidirectional scrolling function of the present invention. Further, the present invention integrates the scroll wheel and the detection components into a single module, which simplifies the assembling process and reduces the size of the product. Therefore, the present invention indeed possesses non-obviousness and meets the conditions for a patent. Thus, the Inventor files the application for a patent. It will be appreciated if the patent is approved fast.

The present invention has been described in detail with the embodiments. However, the embodiments described above are only to exemplify the present invention but not to limit the scope of the present invention. Therefore, any equivalent modification or variation according to the spirit of the present invention is to be also included within the scope of the present invention.

What is claimed is:

1. A scroll wheel module comprising:
a scroll wheel;
a displacement seat, accommodating said scroll wheel, having a receiving member that receives said scroll wheel and implements said displacement seat to move in the same direction as said scroll wheel moves, and having at least one actuation member; and
a carry seat, arranged outside said displacement seat, having at least one instruction switch corresponding to said actuation member, wherein at least one support member is arranged in between said displacement seat and said carry seat; said support member implements said displacement seat to move horizontally inside said carry seat, which makes said actuation member trigger said instruction switch to generate and output an instruction signal.

2. The scroll wheel module according to claim 1, wherein said support member extends from said displacement seat and presses against said carry seat.

3. The scroll wheel module according to claim 1, wherein an elastic member is arranged below said displacement seat and implements said displacement seat to have a tilt displacement travel.

4. The scroll wheel module according to claim 3, wherein a movement member is arranged within the range of said tilt displacement travel of said displacement seat and used to trigger a tilt detection switch.

5. The scroll wheel module according to claim 4, wherein a first incline and a second incline are oppositely arranged in said displacement seat and said movement member.

6. The scroll wheel module according to claim 1, wherein a rotation detection unit is arranged in said carry seat and used to detect a rotation displacement of said scroll wheel.

7. The scroll wheel module according to claim 1, wherein a first workpiece and a second workpiece are assembled to form said carry seat.

8. The scroll wheel module according to claim 7, wherein said first workpiece and said second workpiece are fastened to each other with a fastening member.

9. The scroll wheel module according to claim 1, wherein said carry seat has a motion hole where said receiving member is pivotally installed.
